(19) United States
(12) Patent Application Publication
(10) Pub. No.: US 2007/0008996 A1
(43) Pub. Date: Jan. 11, 2007

(54) Laser wavelength stabilization for pumping purposes using adjusted Fabry-Perot filter

(76) Inventors: Blair Linville, Lenox, MA (US); Igor E. Trofimov, Long Valley, NJ (US)

Correspondence Address: BLANK ROME LLP, 600 NEW HAMPSHIRE AVENUE, N.W., WASHINGTON, DC, 20037, US

(21) Appl. No.: 11/451,620

(22) Filed: Jun. 13, 2006

Related U.S. Application Data
(60) Provisional application No. 60/689,549, filed on Jun. 13, 2005.

(51) Int. Cl. H01S 3/10; H01S 3/13; H01S 3/08

(52) U.S. Cl. 372/32; 372/98; 372/23

(57) ABSTRACT

In a wavelength-stabilized pumped laser, the Fabry-Perot cavity of the laser chip is initially tuned so as to fit at least two absorption lines of the pumping medium. A Fabry-Perot cavity of a filter disposed in the cavity selects multiple lines fitting the absorption lines of the pumping medium.

### REFERENCE TO RELATED APPLICATION

The present application claims the benefit of U.S. Provisional Patent Application No. 60/689,549, filed Jun. 13, 2005, whose disclosure is hereby incorporated by reference in its entirety into the present application.

### FIELD OF THE INVENTION

The present invention is directed to pumped lasers and more particularly to pumped lasers using Fabry-Perot filters as wavelength stabilization elements.

### DESCRIPTION OF RELATED ART

A high-power laser die typically has a high-reflectivity coating on the back facet and a very-low-reflectivity (2-5%) coating on its front facet. The high-reflectivity coating and a partially reflective element disposed in front of the laser die define a Fabry-Perot (FP) cavity for generation of laser light. The die itself is relatively long (1-3 mm). The effective refractive index of the laser medium is about 3-3.5. Such a combination of the optical properties and geometry results in an almost wavelength-independent resonator. In FIG. 1, plot (a) shows a typical spectrum of a high-power semiconductor laser operating near 1.5 micron. Spectrum width is about 10 nm.

The output spectrum of the laser is governed by the gain and propagation losses of the laser medium. Unfortunately, the gain spectrum in semiconductor lasers is rather broad and is quite sensitive to the temperature; consequently, the laser output spectrum is broad (particularly in the long-wavelength region), and its peak moves with temperature (0.5 nm/° C.). Both effects are detrimental to the efficient optical pumping of a solid-state laser.

In the majority of cases, the pumped medium has a set of absorption lines, and the pumping source is tuned to either one of the absorption lines. Different techniques are utilized to achieve wavelength stabilization. One such technique involves the use of a Fabry-Perot filter within the laser cavity. The Fabry-Perot filter is typically constructed as a thin plate with reflective coatings on both sides.

A thin parallel plate with reflective coatings on both sides transmits light with an incident intensity I₀ such that the transmission intensity spectrum Iₜ as a function of wavelength λ is

$${I}_{t} = {I}_{0} \frac{1}{1 + \frac{4 R}{{( 1 - R )}^{2}} \cdot {sin}^{2} ( \frac{2 π nd}{λ} )} \qquad ( 1 )$$

where n is the refractive index of the plate, d is its thickness, and R is the reflectivity of the coatings. In FIG. 1, plot (b) shows the transmission characteristics of a Fabry-Perot filter. Ideally, peak values correspond to the unity value (that is, perfect transmission).

The reflection spectrum of a Fabry-Perot filter with a mirror behind the filter is also shown in FIG. 1, plot (b). The expression for the reflection spectrum R is given by Eq. (2), where R₀ is the reflectivity of the semi-transparent mirror that is placed behind the Fabry-Perot filter.

$$R = {R}_{0} \times ( 1 - \frac{1}{1 + \frac{4 R}{{( 1 - R )}^{2}} \cdot {sin}^{2} ( \frac{2 π nd}{λ} )} ) \qquad ( 2 )$$

If a 200-micron thin glass plate (n=1.5) with 27% coatings on both sides is put in front of the laser, the transmission of such plate will be 100% at 1474.7 nm and 1467.9 nm and will sharply reduce to below 40% in between.

However, in the prior art, a Fabry-Perot filter in the lasing cavity has been tuned to only one absorption line of the medium. Thus, the problems noted above have not been adequately addressed.

A variety of other techniques are known in the art for stabilizing a pumped laser. However, they do not adequately address the above-noted problems of the output spectral width and the temperature-dependent peak. U.S. Pat. No. 4,998,256 to Oshima et al, U.S. Pat. No. 5,428,700 to Hall, and U.S. Pat. No. 6,370,170 to Glance use complicated active stabilization, which it would be desirable to avoid. U.S. Pat. No. 6,320,888 to Tanaka et al uses a temperature coefficient adjusting material, which does not fully address the above problems.

### SUMMARY OF THE INVENTION

It is therefore an object of the invention to address those problems.

It is another object of the invention to do so without requiring an active feedback control system.

To achieve the above and other objects, the present invention is directed to the use of a Fabry-Perot filter as a wavelength stabilized element for pumping. The Fabry-Perot cavity of the laser chip is initially tuned so as to fit at least two absorption lines of the pumping medium. The Fabry-Perot cavity of the filter selects from the plurality of emission lines of the Fabry-Perot cavity of the chip only those lines fitting the absorption lines of the medium. Given that a few lines correspond to the Fabry-Perot filter conditions, one should not worry about wavelength shift of the chip, since as the wavelength shifts, the Fabry-Perot filter will still select only those wavelengths corresponding the absorption lines of the pumped medium.

Often, solid state lasers have absorption spectra which consist of more than one closely separated lines. For example, Er-doped YAG has absorption lines at 1475, 1470 and 1465 nm; such lines are shown in FIG. 1, plot (d). By proper selection of the plate thickness, the output spectrum of the diode pump laser will be transformed and stabilized to the best overlap with these lines, achieving high conversion efficiency and low sensitivity to the ambient temperature.

An important aspect of the invention is in selecting multiple peaks (rather than single peak that is typical for wavelength selection schemes). In addition, in some embodiments, fine tuning of the wavelength can be performed by changing the tilt angle of the Fabry-Perot filter.

Most importantly, it is possible to select the mode spacing of the Fabry-Perot filter in such a way that a wavelength shift of the semiconductor laser will lead only to power re-distribution between spectrum peaks selected for pumping. Wide enough spacing will prevent non-selected neighbor peaks from being fired if the wavelength shift of the semiconductor laser is within a few nanometers.

### BRIEF DESCRIPTION OF THE DRAWINGS

FIG. 1 shows spectral plots useful for understanding the preferred embodiment;

FIG. 2 shows a schematic diagram of a solid-state laser according to the preferred embodiment; and

FIG. 3 shows a schematic diagram of a solid-state laser according to a variation of the preferred embodiment.

### DETAILED DESCRIPTION OF THE PREFERRED EMBODIMENT

A preferred embodiment of the present invention and variations thereof will bet set forth in detail with reference to the drawings, in which like reference numerals refer to like elements throughout.

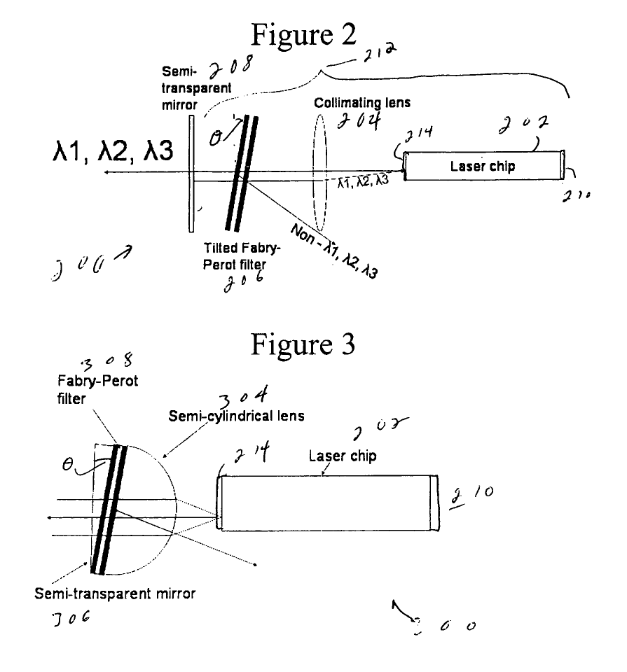

FIG. 2 shows a pumped laser 200 according to the preferred embodiment. The laser 200 includes a laser chip 202, a collimating lens 204, a Fabry-Perot filter 206 tilted at an angle 0, and a semitransparent mirror 208. The laser chip 202 has a high-reflectivity coating 210 on its back surface and a low-reflectivity coating 214 on its front surface. The semitransparent mirror 208 and the high-reflectivity coating 210 define a lasing cavity 212.

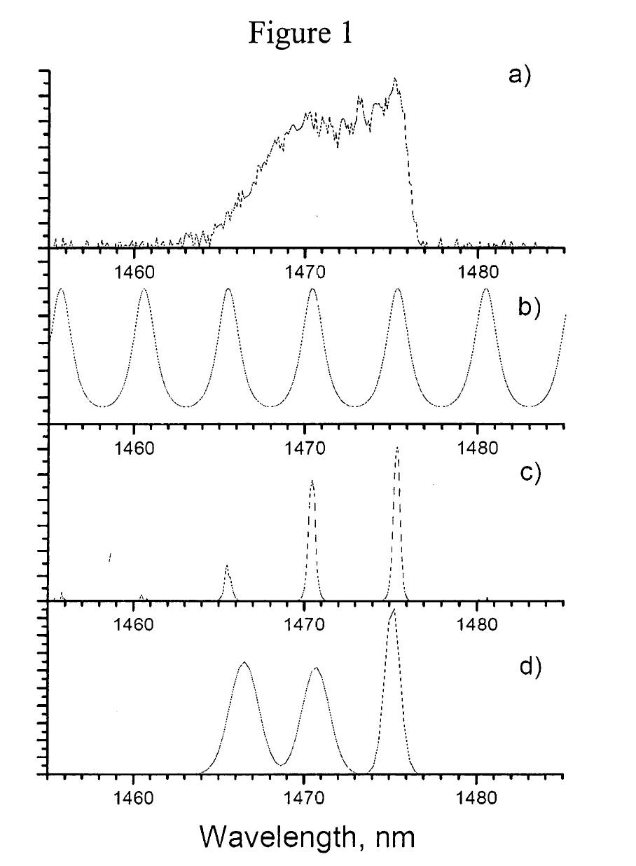

As noted above, the laser chip 202 emits a broadband spectrum such as the one shown in FIG. 1, plot (a). Also, the material of the laser chip 202 has multiple absorption lines at wavelengths λ₁, λ₂, λ₃. The laser cavity 212 is tuned so that the emission lines of the laser are at λ₁, λ₂, λ₃. In addition, the Fabry-Perot filter 206 is tuned to transmit λ₁, λ₂, λ₃ and to reflect other wavelengths within the emission spectra of the laser chip 202.

Because of the tilt of the Fabry-Perot filter 206, the wavelengths reflected by the Fabry-Perot filter 206 are discarded. However, because the Fabry-Perot filter 206 is tuned to select multiple wavelengths rather than just one, the above-noted problems of the prior art are overcome.

In FIG. 1, plot (c) shows the expected laser spectrum with the selective feedback described above. One can see that essential overlap with Er:glass absorption spectrum is achieved.

FIG. 3 shows a variation of the preferred embodiment. In FIG. 3, the laser 300 offers an integrated solution that can be used for wavelength stabilization not only of single diode chips, but also of pumping laser arrays. A semi-cylindrical lens 304 is constructed as an integrated unit that incorporates a Fabry-Perot filter 308 and a semitransparent mirror 306. For a pumping laser array, multiple laser chips 202 can be used with a single semi-cylindrical lens 304. Otherwise, the concepts described above with respect to the laser 200 apply equally to the laser 300.

While a preferred embodiment and modifications thereof have been described in detail above, those skilled in the art who have reviewed the present disclosure will readily appreciate that other embodiments can be realized within the scope of the present invention. For example, numerical values are illustrative rather than limiting, as are disclosures of specific materials. Therefore, the present invention should be construed as limited only by the applied claims.

We claim:

1. A wavelength-stabilized laser comprising:
a pumping medium having a plurality of absorption lines;
optics for defining a Fabry-Perot cavity in which the pumping medium is disposed, the Fabry-Perot cavity being tuned to provide an emission spectrum comprising at least two of the plurality of absorption lines; and
a Fabry-Perot filter disposed in the Fabry-Perot cavity, the Fabry-Perot filter being tuned to select only said at least two of the plurality of absorption lines.

2. The wavelength-stabilized laser of claim 1, wherein the Fabry-Perot filter is tuned to transmit said at least two of the plurality of absorption lines.

3. The wavelength-stabilized laser of claim 2, wherein the Fabry-Perot filter is tilted relative to a direction of emission of light from the pumping medium such that light reflected from the Fabry-Perot filter is not transmitted back to the pumping medium.

4. The wavelength-stabilized laser of claim 3, further comprising a lens disposed in the Fabry-Perot cavity.

5. The wavelength-stabilized laser of claim 4, wherein the lens is a collimating lens disposed in the Fabry-Perot cavity between the Fabry-Perot filter and the pumping medium.

6. The wavelength-stabilized laser of claim 3, wherein the lens and the Fabry-Perot filter are integrally formed as a unit.

7. The wavelength-stabilized laser of claim 6, wherein the lens is a semi-cylindrical lens.

8. The wavelength-stabilized laser of claim 7, wherein the lens, the Fabry-Perot filter, and part of the optics for defining the Fabry-Perot cavity are integrally formed as said unit.
